(19) United States
(12) Patent Application Publication
(10) Pub. No.: US 2005/0235110 A1
(43) Pub. Date: Oct. 20, 2005

(54) Method, device and memory controller for adapting data transfer bus

(76) Inventor: Kimmo Mylly, Julkujarvi (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/514,580

(22) PCT Filed: May 16, 2002
(86) PCT No.: PCT/IB02/01671

§ 371 Date: Jun. 17, 2005

(51) Int. Cl. G06F 12/00

(52) U.S. Cl. 711/115; 710/100

(57) ABSTRACT

The invention provides a concept to adjust the performance of a data transfer bus connecting a plurality of memory modules in accordance with individual performance levels of the addressed memory modules. Particularly, the performance adjustment is employed to adjust the performance of memory accesses to either internally connected memory memory modules of an externally connected device. The performance of accesses to externally connected memory modules is limited to several limitations in comparison to accesses to internally connected memory modules. The individual performance level may comprise information bus and/or information about the clock frequency. The concept of the present invention allows to implement only one data transfer bus connecting memory of an electronic device offering the possibility to a user to extend the available amount of memory by plugging onto an external memory module such as a MultiMediaCard while the access performance to internally connected memory modules is not affected thereby. Further the concept of the present invention introduces also a handshaking procedure for obtaining the performance levels of the connected memory modules to be employed during data transfer thereto of therefrom, respectively.

The present invention relates to a data transfer bus, particularly to a data transfer bus adaptable to certain communication properties. Further, the present invention relates to a memory controller for controlling the data transfer bus and for adapting the communication properties of the data transfer bus to pre-defined properties.

Nowadays, electronic devices such as mobile phones, MP3-players, digital cameras, personal digital assistances (PDA), digital organizers and the like require mass storage systems to be able to operate. These electronic devices are based on microprocessor operated systems employing electronically readable and/or writeable storage systems, particularly random access memory and read only memory, respectively. The memory is used to store data and/or instructions in accordance with applications executed by a microprocessor. Normally, the random access memory and read only memory, respectively, are built-in memories connected to the microprocessor via a dedicated data transfer bus which is adapted to the performance of the microprocessor and/or the applied memories. The restriction to only internal memories, however, may not meet the desires and wishes of users to adapt the available memory to individual necessities. Therefore, most portable electronic devices of the type described above offer extension slots for taking in memory extension modules.

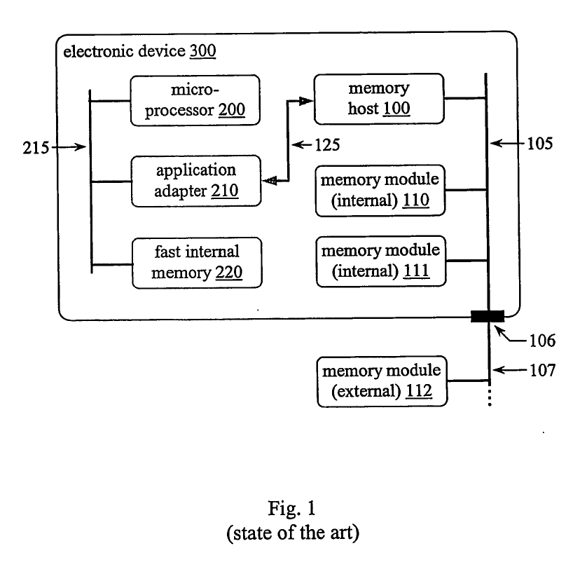

FIG. 1 shall illustrate a typical design of an electronic device 300 based on a microprocessor operating system of state of the art. The depiction of FIG. 1 is reduced to the invention related parts of such an electronic device. A microprocessor 200 operating the electronic device 300 may be connected to a fast internal memory 220 via a dedicated data transfer bus 215. Accordingly, the data transfer bus 215 is preferably able to communicate fast data between microprocessor 200 and fast internal memory 220. In order to provide the possibility to a user to extend the internal memory of the electronic device by plugging onto an external extension module 112 a dedicated memory extension module connector 106 is implemented. The external extension module 112 is connected via an external connection 107, the extension module connector 106 and an internal data transfer bus 105 to a memory host controller 100 which is in communication with the microprocessor 200 via an application adapter 210 and the data transfer bus 215. The memory host controller 100 and application adapter 210 are interconnected through a dedicated connection 125. Such a data transfer bus 105 may be also able to connect a plurality of memory modules which may be connected thereto internally or externally. FIG. 1 illustrates the additional internally connected memory module 110 and the memory module 111.

The connection of special additional external memories is subject to a plurality of performance limiting conditions. The performance of external memory modules is affected above all by line capacitance due to a greater not optimally adapted length, the connectors and an electro static discharge (ESD) protection circuit. Additional internal memory modules connected to the same data transfer bus, such as shown in FIG. 1, are accordingly also subject to the performance limitation. Thus the performance of internally connected memory modules is limited by conditions which do not apply thereto. Therefore, in order to provide optimal performance of both internal memory and externally connected memory, hitherto separate memory host controllers for each memory type have been used.

The object of the present invention is to provide a method for adapting the transfer performance of a data transfer bus controlled by a memory host controller such that the respective performance limits of the connected memory are best exploited. A further object of the present invention is to provide a corresponding apparatus able to operate the aforementioned method and a system implementing the aforementioned method.

The object of the invention is attained by a method, an apparatus, a computer program and a system which are characterized by what is claimed in the accompanying independent claims. Further embodiments of the invention are the subject of the corresponding dependent claims.

The concept of the present invention provides the advantage that both internal memory and external memory can be connected to the same data transfer bus operated by a flexible performance control so that both types of memories can be accessed with the optimal and preferably highest performance for each. The employment of only one data transfer bus and hence only one controller for controlling thereof reduces the complexity of the design of the electronic device due to less components such as controllers in application specific integrated circuits (ASIC), less signals to be supplied to ASICs and less complex software drives for controlling the operation of the data transfer buses.

Further, the amount of the pins of the ASIC is reduced as only one bus is needed and the number of the controllers is reduced because the same controller is used for external and internal memories. Moreover, the size of the package of the ASIC can be reduced. Next, the amount of the silicon on which the device is contructed, i.e. the amount of die which determines the amount of the circuit material, can be reduced. This advantage has the additional effect that the size of the package of ASIC can be reduced. Next, the size of the connector can be smaller and the amount of the pins in it can be reduced, while the size of the connector and the amount of the pins (of the external memory) will not restrict the use of the internal memory in any way.

According to an embodiment of the invention, a method for adapting communication properties of a common data transfer bus is provided. The common data transfer bus connects a plurality of memory modules for communicating data. The adaptation of the common data transfer bus is based on communication property information which relates to the communication properties of the connected memory modules. This communication property information is retrieved, for example from a dedicated storage or cache. The adapted common data transfer bus is used to communicate data to and from the memory module.

According to an embodiment of the invention, the common data transfer bus connects at least two memory modules, wherein these two memory modules have separate communication properties and consequently different communication property information relates to these two memory modules. The adapting of the common data transfer bus is performed in order to adapt individually the common data transfer bus with respect to one of the memory modules for allowing adapted access to this memory module, particularly for an adapted access to this memory module.

According to an embodiment of the invention, the communication property information includes a plurality of single properties relating to the communication properties of memory modules and consequently also to the communication properties of the common data transfer bus since these communication properties have to be taken into account in order to provide access thereto. The selection of the communication property information may be based on a clock frequency information, a bus with information, a timing requirement information and a clock edge triggering information.

According to an embodiment of the invention, the communication property information relating to a memory module of the plurality of memory modules connected to the common data transfer bus is obtained by an initialization process. The initialization process comprises a transmitting of at least one request via the common data transfer bus. The request comprises at least one command instructing a memory module to retransmit communication property information. The communication property information is retrieved from the memory module and preferably, is stored to be retrieved for adapting communication properties of the common data transfer bus.

According to an embodiment of the invention, the at least one request is a broadcast request. A broadcast request is a single request transmitted via the common data transfer bus and received by each connected memory module.

According to an embodiment of the invention, the request is addressed to a certain memory module. Therefore, the request may comprise an address information addressing this certain memory module.

According to an embodiment of the invention, the transmitting of the request, the receiving of the information and the storing of the information is repeated for each memory module connected to the common data transfer bus.

According to an embodiment of the invention, the common data transfer bus is operated in accordance with the MultiMediaCard standard. The specification of the MultiMediaCard standard can be obtained from the MultiMediaCard Association (MMCA). Additionally, the common data transfer bus is operated in accordance with the Secure Digital Memory Card (SD Memory Card) standard. The specification of the Secure Digital Memory Card (SD Memory Card) standard can be obtained from the Secure Digital Group (SD Group).

According to an embodiment of the invention, a software tool for adapting communication properties of a common data transfer bus is provided. The software tool comprises program portions for carrying out the operations of the aforementioned methods when the software tool is implemented in a computer program and/or executed.

According to an embodiment of the invention, there is provided a computer program for adapting communication properties of a common data transfer bus. The computer program comprises program code portions for carrying out the operations of the aforementioned methods when the program is executed on a processing device, a computer or a network device.

According to an embodiment of the invention, a computer program product is provided which comprises program code portions stored on a computer readable medium for carrying out the aforementioned methods when said program product is executed on a processing device, a computer or network device.

According to an embodiment of the invention, a memory controller for adapting communication properties of a common data transfer bus is provided. The data transfer bus connects a plurality of memory modules. The adaptation of the common data transfer bus is based on a communication property information. The communication property information relates to a certain memory module out of the plurality of connected memory modules. This information is retrieved, for example from a dedicated storage or cache of the memory controller. The communication properties of the common data transfer bus is adapted in accordance with the retrieved communication property information. The adapted common data transfer bus is used to communicate data to and from the memory module, respectively, to which the communication property information relates.

According to an embodiment of the invention, the memory controller is additionally adapted to operate the aforementioned methods according to previous embodiments of the invention. Particularly, the memory controller is adapted to operate the aforementioned method of obtaining the communication property information from a memory module with respect to an embodiment of the invention. Further, the memory controller may be able to operate in accordance with the MultiMediaCard standard or in accordance with the Secure Digital Memory Card (SD Memory Card) standard.

According to an embodiment of the invention, a system for adapting communication properties of a common data transfer bus is provided. The system comprises a memory controller, the common data transfer bus and a plurality of memory modules connected to the common data transfer bus. The memory controller is able to adapt communication properties of the common data transfer bus according to an embodiment of the present invention and with respect to the aforementioned memory controller.

According to an embodiment of the invention, an electronic device having an adaptable common data transfer bus is provided. The electronic device may be based on the aforementioned system for adapting communication properties of a common data transfer bus according to an embodiment of the invention. The electronic device may comprise within its housing a memory controller, a common data transfer bus and at least one memory module. The memory controller may be a memory controller for adapting communication properties of the common data transfer bus with respect to the aforementioned memory controller and according to an embodiment of the present invention. Additionally, the electronic device offers a connector for connecting at least one additional memory module. Preferably, the additional memory module is a memory module connected from outside to the housing of the electronic device. Preferably, the additional memory module may be a detachable memory extension module.

The invention will be described in greater detail by the means of preferred embodiments with reference to the accompanying drawings, in which

FIG. 1 shows a block diagram illustrating schematically an electronic device of state of the art,

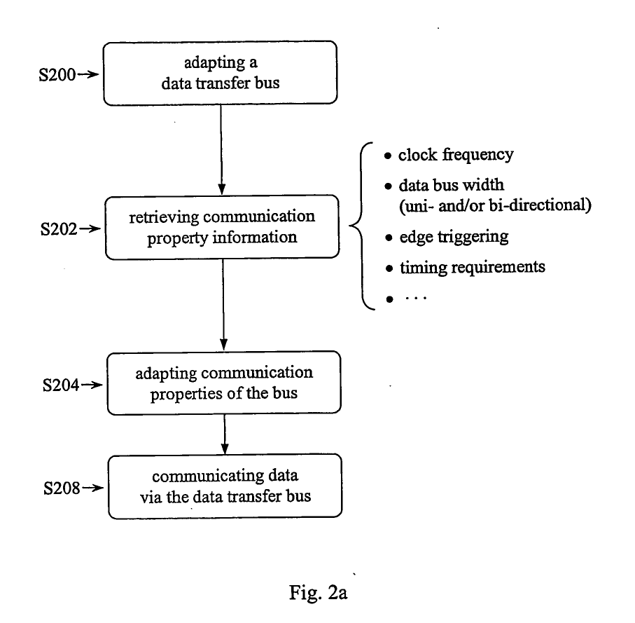

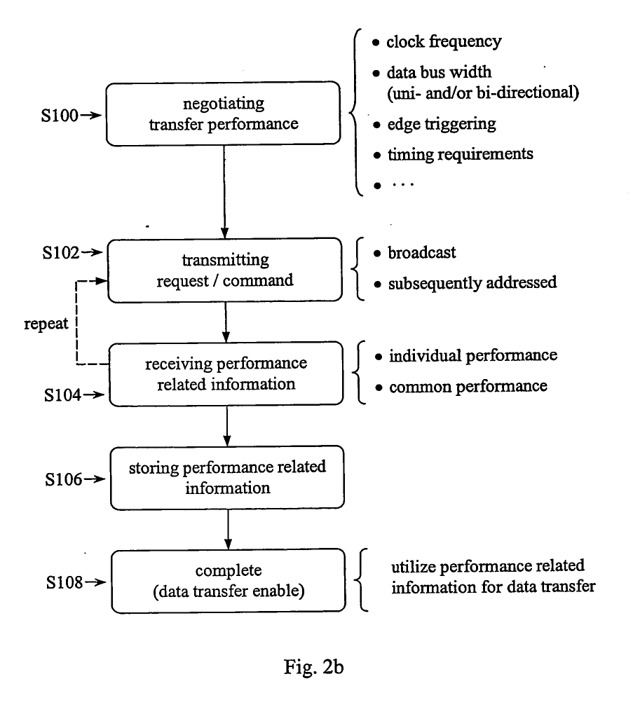

FIG. 2a shows a flow diagram illustrating a method according to an embodiment of the invention,

FIG. 2b shows a flow diagram illustrating a further method according to an embodiment of the invention,

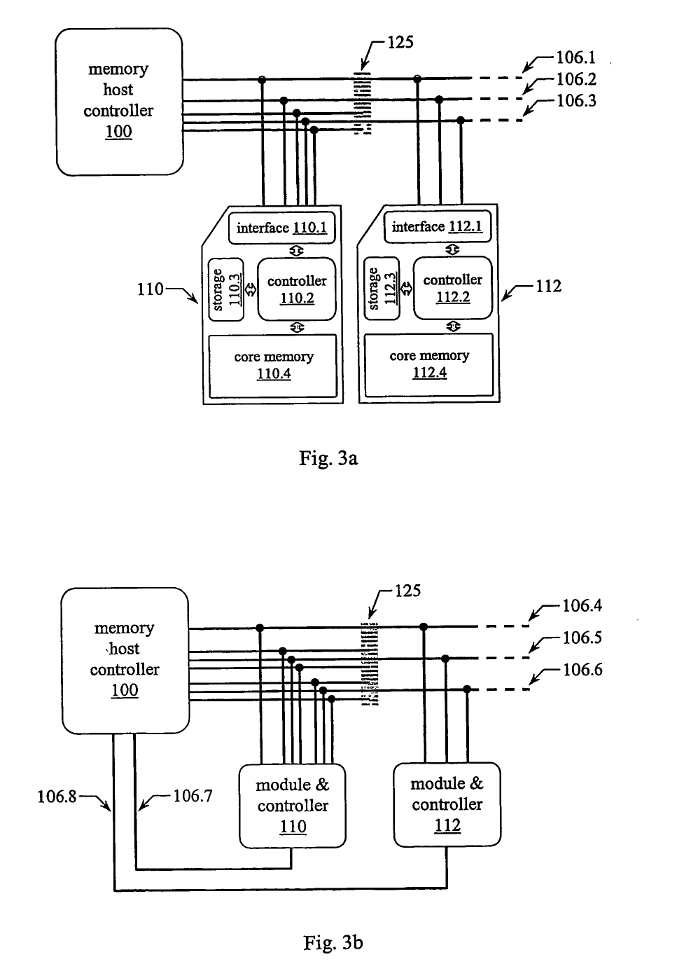

FIG. 3a shows a block diagram illustrating a bus system according to an embodiment of the invention,

FIG. 3b shows a block diagram illustrating a further bus system according to an embodiment of the invention,

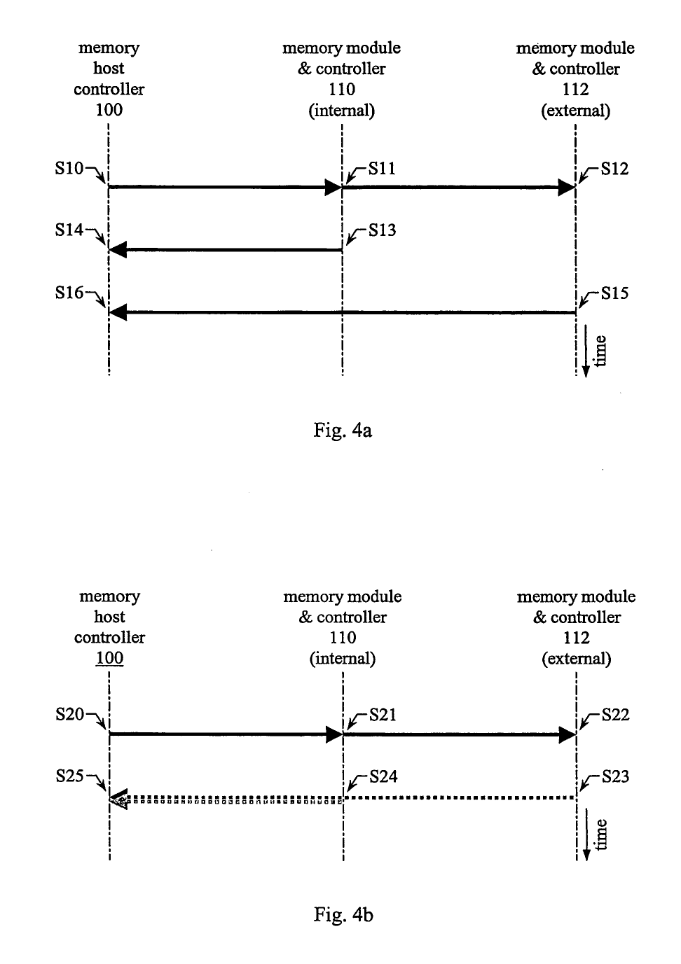

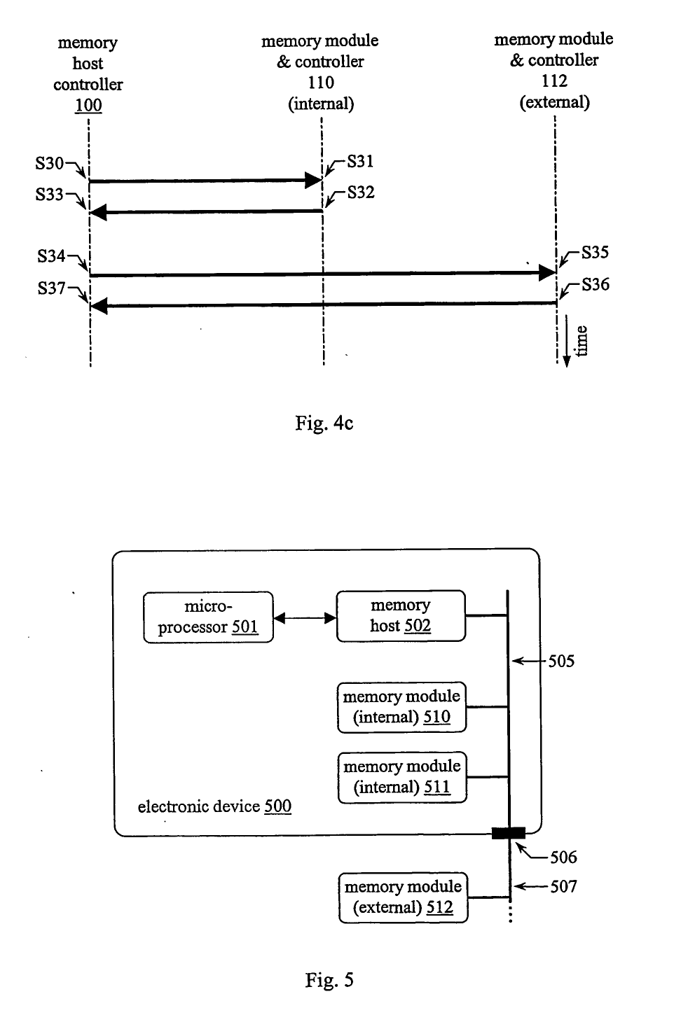

FIG. 4a shows a flow chart illustrating a timely sequence in accordance with a method according to an embodiment of the invention,

FIG. 4b shows a flow chart illustrating a timely sequence in accordance with a method according to a further embodiment of the invention,

FIG. 4c shows a flow chart illustrating a timely sequence in accordance with a method according to a further embodiment of the invention and

FIG. 5 shows a block diagram illustrating schematically an electronic device according to an embodiment of the invention.

The following description relates to the method, to the apparatus and to the system. Same or equal parts shown in the figures will be referred by the same reference numerals.

In accordance with concept of the present invention, communication property information is available to be employed for the performing data communication with a memory module connected to the data transfer bus. The following FIG. 2 will introduce this concept.

FIG. 2a shows a flow diagram illustrating the method for accessing memory modules according to an embodiment of the invention.

In an operation S200, the operational sequence for adapting a common data transfer bus is initiated. A plurality of memory modules are connected to the common data transfer bus. The memory modules may have different communication properties. The adaptation of the common data transfer bus is performed in order to adapt individually the common data transfer bus with respect to one of the memory modules for allowing adapted access to this memory module, preferably for optimally adapted access to this memory module.

The data communication with the memory module may be understood as for example a reading operation of data contained in the memory module, a writing operation of data to be contained in the memory module, a deletion operation of data contained in the memory module and the like.

In an operation S202, a communication property information in accordance with a certain memory module is retrieved. A dedicated storage or cache may provide this information. Communication property information may be available for each memory module connected to the common data transfer bus.

In brief, communication property information may be based on at least one of the following information:
clock frequency information,
bus width information,
timing requirement information and
clock edge triggering information.

The clock frequency information comprises information about the clock frequency valid for the operation of a memory module. Preferably, the clock frequency information comprises information about an upper clock frequency limitation for the operation.

The bus width information comprises information about the number of single data lines comprised by the data transfer bus which can be employed for communicating data. Therefore, the number of single data lines which are employed during a data communication process may be termed as data bus width.

The clock edge triggering information and the timing requirement information comprises information relating to certain internal properties of the memory modules. The clock edge triggering information and the timing requirement information comprise for example information which are necessary in order to perform data communication with double data rate memory and with single data rate memory. Therefore, the clock edge triggering information comprises information on which clock edges single data signals are transmitted. The timing requirement information comprises for example timing information about the refresh cycle interval and similar memory timing parameters.

The above presented selection should not be limited to the presented items. All relevant communication property information relating to connected memory modules for performing proper access should be covered.

In order to operate the common data transfer bus optimally the communication properties, here the clock frequency, the data bus width, timing requirements and clock edge triggering, of the common data transfer bus are adapted to the limitations and/or requirements provided by a certain memory module with which a data communication may be performed.

Further, it should be noted, that the above presented selection of communication property information determine the data throughput of a data transfer bus. The performance of the data transfer bus is achieved in dependence on this communication property information or communication parameters, respectively.

In an operation S204, the communication property of the common data transfer bus may be adapted in accordance with the retrieved communication property.

In an operation S208, the adapted common data transfer bus may be utilized for communicating with the memory module in accordance to which the adapting process has been performed.

The operations S200 to S208 present an operational sequence according to an embodiment of the present invention for preparing the data transfer bus for a communication of data to a certain memory module or from a certain memory module. The preparation may serve to perform the data communication with optimally adapted data transfer bus, individually adapted to the limitations of the certain memory module participating on the data communication in order to obtain a maximal overall data rate.

Commonly, data transfer buses are controlled and operated by dedicated bus controllers. For example the dedicated bus controller may be able to control the aforementioned communication properties of the data transfer bus such that the retrieved communication property information gets valid for the following communication.

It should be noted that the clock frequency information may be an information relating to the maximum valid and applicable clock frequency for operating the memory module. Lower frequencies may also be employed for operating the memory module. The data bus width information may be an information relating to the number of data lines comprised by the common data transfer bus for data communication. The maximum number of employable data lines may be defined by the wiring of the memory module or by a connector used to plug the memory module onto the common data transfer bus. At minimum a single data line has to be provided for data communication. It may be possible to employ less than the maximum number of provided data lines for data communication so that the data bus width may be also interpreted as an upper limitation. The clock edge triggering information and the timing requirement information may also comprise information relating to an optimally adapted operation or an operation of maximal performance. Default communication properties in accordance to the clock edge triggering information and the timing requirement information may be available such that the plurality of memory modules may be operated in accordance with a common set of communication properties.

The following sequence of operations present a possible process for obtaining the employed communication property information from the connected memory modules, preferably during an initializing process of the memory modules.

FIG. 2b shows a flow diagram illustrating a method for obtaining communication property information according to an embodiment of the invention.

In an operation S100, a negotiating operation of the information relating to the transfer performance of the connected memory modules is initiated. The memory modules is connected to a common data transfer bus. The data transfer bus is controlled and operated by a dedicated controlling unit, in the following termed as memory host controller. The memory host controller controls the communication properties of the common data transfer bus in accordance with the communication property information use for communication, particularly the clock frequency, the width of the transfer bus, the kind of clock edge triggering and the timing requirements of the memory modules.

During the following negotiating operation the data transfer bus may be operated by a default setting of the communication properties in order to allow the communication with all connected memory modules. Commonly, such a default setting may comprise a low clock frequency suitable for all connected memory modules, e.g. defined in accordance with a standard specification, the employment of only one data line of the data transfer bus which is the minimal number of data lines necessary for data communication, a default clock edge triggering relating to the single data rate memory and default conservative timing settings.

In an operation S102, at least one request may be transmitted to the memory modules. The request may comprise instructions or commands, respectively, instructing the memory module to transmit back their communication property information.

The request may be a broadcast request which means that one request is transmitted via the data transfer bus and this request is received by each connected active memory module.

Alternatively, an individual request is transmitted to each memory module. Therefore, the request may comprise a memory module address addressing the corresponding memory module. Such addresses may be assigned to the memory modules by an address assigning process carried out before.

In an operation S104, the communication property information requested in the operation S102 is received.

Corresponding communication property information is received from each memory module. The transmitting of the request and receiving of the corresponding communication property information may be operated subsequently such that the operation S102 and operation S104 may have to be repeated for each connected active memory module. This repeated carrying out of the operation S102 and operation S104 may be employed in connection with the individual addressing of the request to the memory modules. But also a broadcast request may lead to a subsequent receiving of communication property information from each memory module.

Alternatively, a broadcast request leads to a receiving of a single communication property information comprising information about a common performance of all memory modules. The information may be information about highest common performance with which all memory modules may be accessible.

In an operation S106, the communication property information is stored in order to be retrievable for a following communication operation. Such a communication operation basing of communication property information is described above with reference to FIG. 2a.

In an operation S108, the negotiating of the information relating to the transfer performance of the connected memory modules is completed and the communication property information are ready for utilization.

The following FIG. 3a and FIG. 3b are related to a system according to embodiments of the present invention. Both systems can be understood as to be similar and comparable with a memory bus system supporting the MultiMediaCard standard and/or the Secure Digital Memory Card (SD Memory Card) standard but the provided embodiments of the invention are not limited thereto.

FIG. 3a shows a block diagram illustrating a memory bus system according to an embodiment of the invention. The depicted system comprises a memory host controller 100 which controls and operates a data transfer bus, an internal memory module 110 and an external memory module 112.

The data transfer bus comprises the line 106.1, preferably designed as the clock frequency line, the line 106.2, preferably designed as the command line for communicating commands from the memory host controller 100 to the connected memory modules 110 or 112 and for communicating responses from the connected memory modules to the memory host controller 100 and lines 106.3, preferably designed as the data lines for communicating data between the memory host controller 100 to the connected memory modules 110 or 112.

The data transfer bus may provide the probability to connect memory modules internally as well as also externally. It should be noted, that the expression internally connected memory module shall indicate that such a memory module is comprised by the same housing of an electronic device also comprising the memory host controller, whereas the expression external memory module shall indicate that such a memory module is connected to the data transfer bus via a connector which may be provided by a housing of the electronic device. Preferably, the external memory module may be detachable. Accordingly, the data transfer bus may be distinguished upon an internal part of the data transfer bus which is the part between the memory host controller 100 and the connector 125, and an external part of the data transfer bus connected via connector 125. Correspondingly, the memory module 110 may represent an internal memory module 110, whereas the memory module 112 may represent an external memory module 112. The connector 125 may be a connector 125 of a memory module which is designed for plugging in a memory module such as a memory module 112.

The internal part of the data transfer bus and the external part thereof may differ. Herein the internal part of the data transfer bus comprises three data lines for data communication, whereas the external part comprises one data line. The herein depicted number of data lines are exemplary and shall not be limited thereto. Those skilled in the art may adapt the presented concept to different numbers of data lines.

The internal memory module 110 may represent a plurality of internal memory modules connected to the data transfer bus as well as the external memory module 112 may represent a plurality of internal memory modules connected thereto.

The internal memory module 110 comprises several sub-units for operating in connection with the data transfer bus. Preferably, the internal memory module 110 may include without limiting thereto an interface 110.1, a controller 110.2, a storage 110.3 which alternatively may integrated into the controller 110.2 and a core memory 110.4.

The interface 110.1 may provide the electrical coupling of the memory module 110 to the data transfer bus comprising the lines 106.1, 106.2 and 106.3, though it should be noted, that the data line 106.3 comprises herein three single data lines, which may be also termed as the width of the data transfer bus since the clock frequency line 106.1 and command line 106.2 may be each fixed to a single line. Not depicted but necessary and also comprised by the data transfer bus are power lines which comprise at least a power supplying line and a ground line.

Commands transferred from the memory host controller 100 via the command line 106.2 of the data transfer bus may be interpreted by the controller 110.2. In order to direct commands to a certain memory module the commands may comprise addresses which identify uniquely one of the memory modules connected to the data transfer bus. The commands may indicate or initiate data transfer operations including for example the transmission of data from the memory host controller 100 to the memory module 110 to be stored in the core memory 110.4, transmission of data from the memory module 110 to the memory host controller 100 and the like. The controller 110.2 may support different transmission procedure operations like sequential transmission, block transmission, multiple block transmission and the like. The controller 110.2 may further support additional operations like deletion of data contained in the memory, protecting of data and so on.

The communication property information which may be retrieved from the memory module during an initialization procedure as aforementioned may be stored in the controller 110.2 associated storage 110.3.

The external memory module 112 comprises analog sub-units including an interface 112.1, a controller 112.2, a storage 112.3 and a core memory 112.4. Due to the similar design of the internal memory module 110 and the external memory module 112 the both memory modules may be operated in an equal or at least comparable manner such that the principle operation of the external memory module 112 and its sub-units may be obtained from the description of the internal memory module 110 given above.

The interface 112.1 may provide the electrical coupling of the memory module 110 to the data transfer bus comprising the lines 106.1, 106.2 and 106.3, though it should be noted, that in contrast to the interface 110.1 of the internal memory module 110 the data line 106.3 comprises herein a single data line.

It should be understood that the design of the data transfer bus illustrated in FIG. 3a follows by means of an example the design of the MultiMediaCard standard and especially the MultiMediaCard protocol for data communication but should not be limited thereto. The MultiMediaCard standard is distinguished by a command line and a data line, here a bi-directional command line 106.2 and a bi-directional data line 106.3 employed such as described above in detail. The aforementioned method according to an embodiment of the invention can also be employed on a data transfer bus comprising one or several data lines which are used for data communication between memory module and memory host controller as also for command communication between both such that a separate command line is obsolete.

FIG. 3b shows a block diagram illustrating a memory bus system according to a further embodiment of the invention. The depicted system comprises a memory host controller 100 which controls and operates a data transfer bus, an internal memory module 110 and an external memory module 112.

The data transfer bus comprises the line 106.4, preferably designed as the clock frequency line, the lines 106.5, preferably designed as data-in line for communicating data from the memory host controller 100 to the connected memory modules 110 and 112, and line 106.6, preferably designed as the data-out line for communicating data from the connected memory modules 110 and 112 to the memory host controller 100. Further, the memory modules 110 and 112 are supplied with activation signals provided by the line 106.7 or line 106.8, respectively. The lines 106.7 and 106.8 may be designated as chip select signal lines.

The data transfer bus may provide the probability to connect memory modules internally as also externally. It should be noted, that the expression internal connected memory module shall indicate that such a memory module is comprised by the same housing of an electronic device also comprising the memory host controller, whereas the expression external memory module shall indicate that such a memory module is connected to the data transfer bus via a connector which may be provided by a housing of the electronic device. Preferably, the external memory module may be detachable. Accordingly, the data transfer bus may be distinguished upon an internal part of the data transfer bus which is the part between the memory host controller 100 and the connector 125, and an external part of the data transfer bus connected via connector 125.

Correspondingly, the memory module 110 may represent an internal memory module 110 whereas the memory module 112 may represent an external memory module 112. The connector 125 may be a connector 125 of a memory module bay which is designed for taking in memory module such as memory module 112.

The internal part of the data transfer bus and the external part thereof may differ. Herein the internal part of the data transfer bus comprises three data-in lines and three data-out lines for data communication whereas the external part comprises one data-in line and one data-out line. The herein depicted number of data-in lines and data-out lines are exemplary and shall not be limited thereto. Those skilled in the art may adapt the presented concept to different numbers of data-out and/or data-in lines.

The internal memory module 110 may represent a plurality of internal memory modules connected to the data transfer bus as well as the external memory module 112 may represent a plurality of internal memory modules connected thereto.

The internal memory module 110 and the external memory module 112 comprise several sub-units for operating in connection with the data transfer bus. The principle design of the internal memory module 110 and the external memory module 112 is similar and/or comparable with the design of the memory modules presented and illustrated in FIG. 3a. Both the lines of the data transfer bus and the chip select lines 106.7 and 106.8 are all supplied to the memory modules 110 and 112 or their interfaces, respectively. In case of the internal memory module 110 three data-in lines and three data-out lines are supplied to the corresponding interface, in case of the external memory interface 112 one data-in lines and one data-out line are supplied to the corresponding interface. Not depicted but necessary and also comprised by the data transfer bus are power lines which comprise at least a power supplying line and a ground line.

Commands from the memory host controller to the memory modules may be transferred via the data-in lines 106.5 of the data transfer bus. In order to direct commands to a certain memory module the operation status of the memory modules may be switched by signals supplied thereto via the chip select lines 106.7 and 106.8. Only one memory module is allowed to be active, i.e. to receive or to transmit commands, command responses and/or data via the data transfer bus. The remaining memory modules have to be in an inactive mode, i.e. are not allowed to communicate via the data transfer bus.

The following flow charts shall illustrate the interoperability of the components presented in FIG. 3a and FIG. 3b with reference to the operational sequence of negotiating communication property information illustrated in FIG. 2b. The flow charts of the FIGS. 4a, 4b and 4c describe the data communication between a memory host controller 100, an internal memory module 110 and an external memory module 112 which may all be connected to a common data transfer bus operated and controlled by the memory host controller. The internal memory module 110 may represent a plurality of internal memory modules connected to the data transfer bus as well as the external memory module 112 may represent a plurality of internal memory modules connected thereto.

It should be understood that the design of the data transfer bus illustrated in FIG. 3b follows by means of an example the design of the Secure Digital Memory Card (SD Memory Card) standard and especially the serial peripheral interface (SPI) mode thereof but should not be limited thereto. The Secure Digital Memory Card (SD Memory Card) standard operated in this serial peripheral interface (SPI) mode is distinguished by unidirectional data-in lines and unidirectional data-out lines, here data-in lines 106.5 for communicating data from the memory host controller to the connected memory modules and data-out lines 106.6 for communicating data from the memory modules to the connected memory host controller such as described above in detail. Accordingly, commands from the memory host controller to the memory modules are communicated via the data-in lines. The aforementioned method according to an embodiment of the invention can also be employed on a data transfer bus comprising one or several data lines which are used for bi-directional data communication between memory module and memory host controller as also for command communication between both such that the distinguishing between separate data lines (data-in lines and data-out lines) dedicated to different data communication directions is obsolete.

The Secure Digital Memory Card (SD Memory Card) standard is derived from and bases on the MultiMediaCard standard. The MultiMediaCard standard offers the aforementioned data communication in accordance with the MultiMediaCard protocol. Correspondingly, the Secure Digital Memory Card (SD Memory Card) protocol is derived and based on the MultiMediaCard protocol e.g. by expanding the protocol to some own generic features, a wider data communication bus and the like is obtained. Both the MultiMediaCard standard and the Secure Digital Memory Card (SD Memory Card) standard offer the possibility to employ the serial peripheral interface (SPI) mode for data communication besides their respective bus communication protocols. In particular but not limiting, persons skilled in the art can apply the aforementioned embodiments by considering the respective requirements, conditions and limitations to both the MultiMediaCard standard and the Secure Digital Memory Card (SD Memory Card) standard operated in any adequate bus communication protocol.

FIG. 4a shows a flow chart illustrating a timely sequence in accordance with a method according to an embodiment of the invention.

In an operation S10, a broadcast request may be transmitted from the memory host controller 100 to all connected memory modules, herein the memory module 110 and the memory module 112. The broadcast request may comprise instructions instructing the receiving memory modules to retransmit performance related data.

In an operation S11, the memory module 110 may receive the broadcast request via the data transfer bus.

In an operation S12, the memory module 112 may receive the broadcast request via the data transfer bus.

In an operation S13, the memory module 110 may retransmit a response in accordance with the broadcast request to the memory host controller 100, wherein the response may comprise the requested communication property information.

In an operation S14, the memory host controller 100 receives the response transmitted by the memory module 110. The communication property information may be stored by the memory host controller 100 in order to be retrievable in case of communicating data between the memory module 110 and the memory host controller 100 via the data transfer bus of which the properties are adapted in accordance with the communication property information obtained from the memory module 110.

In an operation S15, the memory module 112 may retransmit a response in accordance with the broadcast request to the memory host controller 100, wherein the response may comprise the requested communication property information.

In an operation S16, the memory host controller 100 receives the response transmitted by the memory module 112. The communication property information may be stored by the memory host controller 100 in order to be retrievable in case of communicating data between the memory module 112 and the memory host controller 100 via the data transfer bus of which the properties are adapted in accordance with the communication property information obtained from the memory module 112.

FIG. 4b shows a flow chart illustrating a timely sequence in accordance with a method according to a further embodiment of the invention.

In an operation S20, a broadcast request may be transmitted from the memory host controller 100 to all connected memory modules, herein the memory module 110 and the memory module 112. The broadcast request may comprise instructions instructing the receiving memory modules to retransmit performance related data.

In an operation S21, the memory module 110 may receive the broadcast request via the data transfer bus.

In an operation S22, the memory module 112 may receive the broadcast request via the data transfer bus.

In an operation S23 and in an operation S24, the memory module 110 and the memory module 112 may retransmit simultaneously a response in accordance with the received broadcast request. Each memory module may compare bit-wise the individually generated response with the response present on the data transfer bus during the retransmission process. In case one memory module recognizes differences it interrupts its transmission process.

In an operation S25, as a result of the operation S23 and S24 the memory host controller 100 may receive a complete response of one memory module which may comprise communication property information of low values. It should be noted that “communication property information of low values” shall be understood as communication property information including information relating to the lowest performance limits of the connected memory modules, e.g. the smallest width of the data transfer bus and/or the lowest maximal clock frequency and the like.

FIG. 4c shows a flow chart illustrating a timely sequence in accordance with a method according to a further embodiment of the invention.

In an operation S30, a request may be transmitted from the memory host controller 100 to the memory module 110. The request may be addressed to the memory module 110, for example by including an address information or by activating of the memory module 110 via a chip select signal (e.g. line 106.7 shown in FIG. 3b).

In an operation S31, the memory module 110 may receive the request.

In an operation S32, the memory module 110 may retransmit a response in accordance with the broadcast request to the memory host controller 100, wherein the response may comprise the requested communication property information.

In an operation S33, the memory host controller 100 receives the response transmitted by the memory module 110. The communication property information may be stored by the memory host controller 100 in order to be retrievable in case of communicating data between the memory module 110 and the memory host controller 100 via the data transfer bus of which the properties are adapted in accordance with the communication property information obtained from the memory module 110.

In an operation S34, a request may be transmitted from the memory host controller 100 to the memory module 112. The request may be addressed to the memory module 112, for example by including an address information or by activating of the memory module 112 via a chip select signal (e.g. line 106.7 shown in FIG. 3b).

In an operation S35, the memory module 112 may receive the request.

In an operation S36, the memory module 112 may retransmit a response in accordance with the broadcast request to the memory host controller 100, wherein the response may comprise the requested communication property information.

In an operation S37, the memory host controller 100 receives the response transmitted by the memory module 112. The communication property information may be stored by the memory host controller 100 in order to be retrievable in case of communicating data between the memory module 112 and the memory host controller 100 via the data transfer bus of which the properties are adapted in accordance with the communication property information obtained from the memory module 112.

Each of the memory module is requested subsequently in order to retrieve the communication property information.

The following FIG. 5 shows an schematic design of an electronic device employing the above described method and the aforementioned memory controller according to embodiments of the invention.

FIG. 5 shows a block diagram illustrating schematically an electronic device according to an embodiment of the invention. The depiction of FIG. 5 is reduced to the invention related parts of such an electronic device 500. The electronic device 500 comprises a microprocessor 501 operating the electronic device 500. The microprocessor 500 requires commonly memory for data to be processed thereby. In contrast to the FIG. 1 illustrating the state of the art a single common data transfer bus 505 connecting internal memory modules 510 and 511 and providing the capability to connect additional external memory modules, such as memory module 512 is sufficient. As described with reference to FIG. 1, the data transfer buses offering the capability to connect external memory underlay several limiting conditions which limit the throughput of the adequate data transfer buses. The limitations are inadequate since internal memory have often to be accessible with a high data throughput in order to enable a satisfying operation speed of the electronic device 500.

The utilization of a memory host 502 capable to adapt the communication properties of the data transfer bus 502 according to an aforementioned memory controller with respect to an embodiment of the invention allows to provide high data throughput during data communication with the internal memory modules 510 and 511 such as the aforementioned memory module 110. In case of data communication with the external memory module 512 connected to the data transfer bus 505 via connector 506 the communication properties of the common data transfer bus 505 are adapted in accordance with the limiting conditions and requirement which underlay external memory modules.

The usage of only one common data transfer bus within such an electronic device reduces the cost of the electronic device and the design efforts clearly.

It will be obvious to a person skilled in the art that as the technology advances, the inventive concept can be implemented in a number of ways. The invention and its embodiments are thus not limited to the examples described above but may vary within the scope of the claims.

1. A method for adapting communication properties of a common data transfer bus connecting a plurality of memory modules, characterized by
retrieving communication property information of at least one memory module of said plurality of memory modules, said communication property information relating to communication properties of said at least one memory module of said plurality of memory modules, and
adapting said communication properties of said common data transfer bus in accordance with said retrieved communication property information.

2. The method according to claim 1, wherein at least two memory modules of said plurality of memory modules have different communication properties and said method prepares for adapted access to at least one of said plurality of memory modules.

3. The method according to claim 1, wherein said communication property information includes information relating to at least one of a group comprising:
clock frequency information,
bus width information,
timing requirement information, and
clock edge triggering information.

4. The method according to claim 1, wherein said clock frequency information and said bus width information are retrieved by:
transmitting a request via the common data transfer bus, said request instructing at least one memory module of said plurality of memory modules to transmit said clock frequency information and said bus width information,
receiving said clock frequency information and said bus width information, and
storing said clock frequency information and said bus width information.

5. The method according to claim 4, wherein said transmitting of said request via the common data transfer bus comprising:
transmitting a broadcast request via the common data transfer bus, said broadcast request instructing all memory modules of said plurality of memory modules to transmit said clock frequency information and said bus width information.

6. The method according to claim 4, wherein said transmitting of said request via the common data transfer bus comprising:
transmitting a request via the common data transfer bus addressed to at least one memory module of said plurality of memory modules.

7. The method according to claim 6, wherein said operations of transmitting, receiving and storing are repeated for each memory module of said plurality of memory modules.

8. The method according to claim 1, wherein said common data transfer bus is operated in accordance with the MultiMediaCard standard.

9. A software tool for adapting communication properties of a common data transfer bus, comprising program code portions for carrying out the operations of claim 1, when said program is implemented in a computer program for executing on a computer, a user terminal or a processing device.

10. A computer program for adapting communication properties of a common data transfer bus, comprising program code section for carrying out the operations of claim 1, when said program is run on a computer, a user terminal or a processing device.

11. A computer program product for adapting communication properties of a common data transfer bus, wherein said computer program product is comprises program code sections stored on a computer readable medium for carrying out the method of claim 1, when said program product is run on a computer, a user terminal or processing device.

12. A memory controller for adapting communication properties of a common data transfer bus connecting a plurality of memory modules, wherein said memory controller comprises:
retrieving means for retrieving communication property information of at least one memory module of said plurality of memory modules, said communication property information relating to communication properties of at least one memory module of said plurality of memory modules, and
adapting means for adapting a clock frequency of said common data transfer bus in accordance with said clock frequency information.

13. The memory controller according to claim 12, wherein said communication property information includes information relating to at least one of a group comprising:
clock frequency information,
bus width information,
timing requirement information, and
clock edge triggering information.

14. A system for adapting communication properties of a common data transfer bus comprising a memory controller for adapting communication properties of a common data transfer bus, a data transfer bus and a plurality of memory modules connected to said common data transfer bus, wherein said memory controller comprises:
retrieving means for retrieving communication property information of at least one memory module of said plurality of memory modules, said communication property information relating to communication properties of at least one memory module of said plurality of memory modules, and
adapting means for adapting a clock frequency of said common data transfer bus in accordance with said clock frequency information.

15. The system controller according to claim 14, wherein said communication property information includes information relating to at least one of a group comprising:
clock frequency information,
bus width information,
timing requirement information, and
clock edge triggering information.

16. An electronic device having an adaptable common data transfer bus, said electronic device including a housing containing a memory controller, said common data transfer bus, at least one memory module connected to said common data transfer bus and a connector for connecting additional memory modules arranged outside of said housing, wherein said memory controller is a memory controller for adapting communication properties of a common data transfer bus and adapted to operate:
retrieving means for retrieving communication property information of at least one memory module of said plurality of memory modules, said communication property information relating to communication properties of at least one memory module of said plurality of memory modules, and
adapting means for adapting a clock frequency of said common data transfer bus in accordance with said clock frequency information.

17. The electronic device according to claim 16, wherein said communication property information includes information relating to at least one of a group comprising:
clock frequency information,
bus width information,
timing requirement information, and
clock edge triggering information.
